(19) United States
(12) Patent Application Publication
(10) Pub. No.: US 2025/0004845 A1
(43) Pub. Date: Jan. 2, 2025

(54) OPTIMIZING USAGE AND PROVIDING RECOMMENDATIONS TO USERS IN A HYBRID CLOUD ENVIRONMENT

(71) Applicant: International Business Machines Corporation, Armonk, NY (US)

(72) Inventors: Abhishek Malvankar, White Plains, NY (US); Carlos A. Fonseca, LaGrangeville, NY (US); Asser Nasreldin Tantawi, Somers, NY (US); Michael Spriggs, Toronto (CA)

(21) Appl. No.: 18/345,153

(22) Filed: Jun. 30, 2023

(51) Int. Cl. G06F 9/50

(52) U.S. Cl. CPC G06F 9/5038; G06F 9/5072

(57) ABSTRACT

Embodiments of the present invention provide an approach for optimizing usage and providing recommendations to users in a hybrid cloud environment. Specifically, user configuration data and deadline for job execution for a job to be executed is collected. A broker queries available queues to determine a wait time corresponding to each of the available queues for the job based on the user configuration data. The wait times are compared to the deadline for job execution. If the deadline cannot be met, a machine learning module suggests modifications to the user configuration to reduce wait times and meet the deadline.

### TECHNICAL FIELD

The present invention relates to managing a cloud environment, and more specifically to embodiments for optimizing usage and providing recommendations to users in a hybrid cloud environment.

### BACKGROUND

To address the challenge of scaling user jobs in a hybrid cloud environment while improving user experience, reducing wait times, and enhancing resource utilization, using a job scheduler is usually necessary. These scheduling tools allocate resources based on requests made by each individual user, ensuring that their computational needs can be met quickly and efficiently. However, in highly complex environments, which can host thousands of users who require high performance computing capabilities such as machine learning, parallel processing, and graphical processing unit (GPU) support, long waits often remain an issue.

In today's era of big data and increasing demand for high performance computing, meeting user expectations may become more difficult due to rising costs associated with expanding infrastructure capacity and acquiring new specialized computing resources for advanced deep learning frameworks, etc. In cases where there is a mismatch between user request demands and system capabilities, job scheduling issues often persist. Unlike traditional on-premises computing scenarios where servers operate continuously, multi-user computing clusters frequently face challenges due to unequal resource usage by queued-up user tasks. The submission of a job by a user can trigger the scheduling tool to allocate resources whenever possible. This can result in lengthy wait times before execution begins, leading to underused resources, and missed deadlines, ultimately causing user frustration and negatively affecting productivity.

### SUMMARY

Embodiments of the present invention provide an approach for optimizing usage and providing recommendations to users in a hybrid cloud environment. Specifically, user configuration data and deadline for job execution for a job to be executed is collected. A broker queries available queues to determine a wait time corresponding to each of the available queues for the job based on the user configuration data. The wait times are compared to the deadline for job execution. If the deadline cannot be met, a machine learning module suggests modifications to the user configuration to reduce wait times and meet the deadline.

A first aspect of the present invention provides a method for optimizing job scheduling performance in a hybrid cloud environment, comprising: obtaining, by a processor, a user configuration data and a deadline for job execution for a job to be executed; querying, by the processor, available queues to determine a wait time corresponding to each of the available queues for the job based on the user configuration data; comparing, by the processor, the wait times to the deadline for job execution; and suggesting, by the processor, a modification to the user configuration data using a machine learning module to reduce wait times and meet the deadline if the deadline cannot be met.

A second aspect of the present invention provides a computing system for optimizing job scheduling performance in a hybrid cloud environment, comprising: a processor; a memory device coupled to the processor; and a computer readable storage device coupled to the processor, wherein the storage device contains program code executable by the processor via the memory device to implement a method, the method comprising: obtaining, by a processor, a user configuration data and a deadline for job execution for a job to be executed; querying, by the processor, available queues to determine a wait time corresponding to each of the available queues for the job based on the user configuration data; comparing, by the processor, the wait times to the deadline for job execution; and suggesting, by the processor, a modification to the user configuration data using a machine learning module to reduce wait times and meet the deadline if the deadline cannot be met.

A third aspect of the present invention provides a computer program product for optimizing job scheduling performance in a hybrid cloud environment, the computer program product comprising a computer readable storage device, and program instructions stored on the computer readable storage device, to: obtain, by a processor, a user configuration data and a deadline for job execution for a job to be executed; query, by the processor, available queues to determine a wait time corresponding to each of the available queues for the job based on the user configuration data; compare, by the processor, the wait times to the deadline for job execution; and suggest, by the processor, a modification to the user configuration data using a machine learning module to reduce wait times and meet the deadline if the deadline cannot be met.

### BRIEF DESCRIPTION OF THE DRAWINGS

FIG. 1 depicts a block diagram illustrating an example of an environment for the execution of at least some of the computer code involved in performing the inventive methods, in accordance with embodiments of the present invention.

FIG. 2 depicts a block diagram of a system architecture involved in performing the inventive methods, in accordance with embodiments of the present invention.

FIG. 3 depicts example training data for a machine learning model, in accordance with embodiments of the present invention.

FIG. 4 depicts an example user interface that allows a user to provide user input related to a job to be executed, in accordance with embodiments of the present invention.

FIG. 5 depicts a flow diagram related to optimizing usage and providing recommendations to users in a hybrid cloud environment, in accordance with an embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

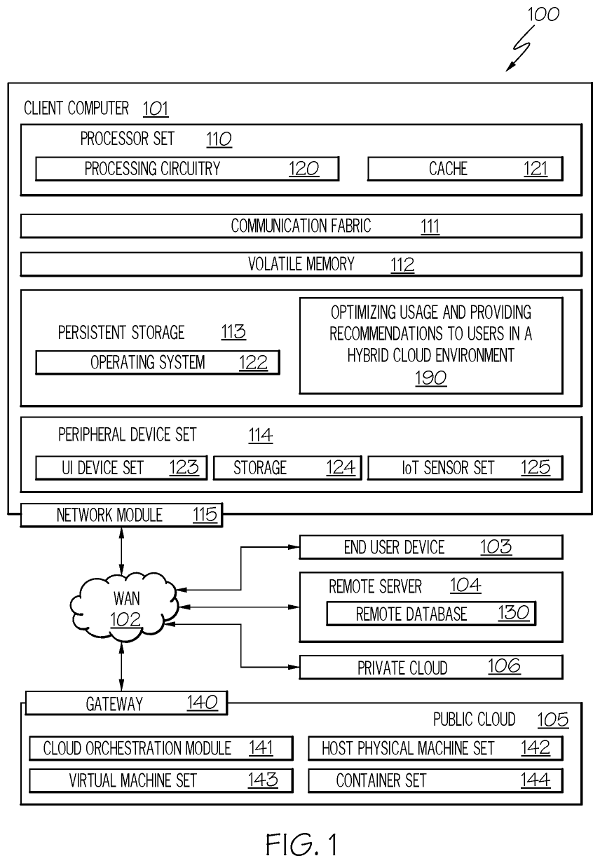

Computing environment 100 of FIG. 1 contains an example of an environment for the execution of at least some of the computer code involved in performing the inventive methods, such as optimizing usage and providing recommendations to users in a hybrid cloud environment technique 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

To improve user experience and efficiently allocate resources in a hybrid cloud environment, it is necessary to use a job scheduler. However, in complex environments with many users requiring high-performance computing capabilities, long wait times can still be an issue. This is particularly challenging in the era of big data, where acquiring new specialized computing resources can be costly. Job scheduling issues can arise when there is a mismatch between user request demands and system capabilities. Multi-user computing clusters frequently face challenges due to unequal resource usage by queued-up user tasks, resulting in underused resources and missed deadlines. Ultimately, this can lead to user frustration and negatively impact productivity.

The approach described herein addresses the need to optimize user experience by recommending a job resource configuration that efficiently utilize available resources in a hybrid cloud environment. By doing so, the inventors aim to reduce the wait time for job execution before the user's deadline. This solution ensures that users can seamlessly access necessary resources and complete their tasks on time, enhancing their overall experience.

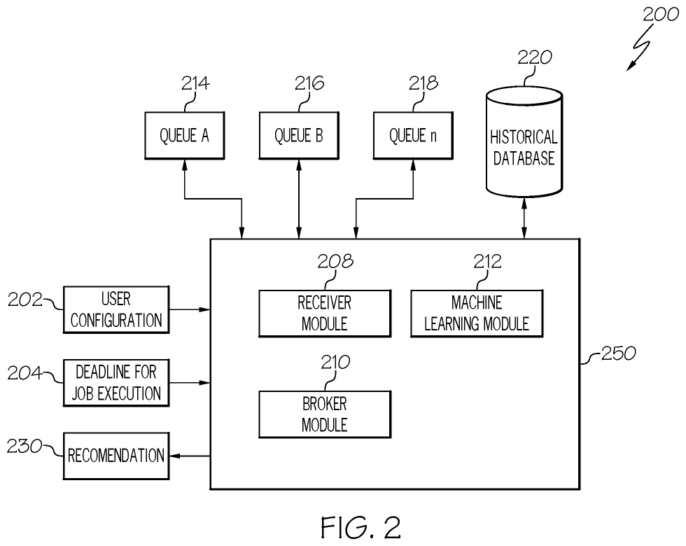

FIG. 2 depicts a block diagram of one or more components of a system environment 200 by which services provided by a configuration engine 250 may be offered as cloud services, in accordance with an embodiment of the present disclosure. In accordance with some embodiments, the configuration engine 250 is configured to recommend a job resource configuration that utilizes available resources in a hybrid cloud environment to reduce user experience issues. As used herein, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

As shown in FIG. 2, configuration engine 250 may include one or more modules, such as receiver module 208, broker module 210 and machine learning module 212. The job scheduling process begins with a user providing user configuration 202 related to a job to be scheduled and a deadline for job execution 204. A job typically refers to a specific task or set of tasks that are submitted to the cloud environment for execution. Jobs are usually processed sequentially and have a defined start and end time. For example, running a batch job to process a large dataset would be considered a job in a cloud environment. Deadline for job execution 204 refers to a date and time by which the job should begin its execution.

For simplicity, much of the detail described herein focuses on job execution rather than workload or application execution. In a cloud environment, a job and workload are not necessarily the same thing. While both terms refer to a set of tasks that need to be executed, they have slightly different meanings and implications in a cloud computing context. A job typically refers to a specific task or set of tasks that are submitted to the cloud environment for execution. Jobs are usually processed sequentially and have a defined start and/or end time. For example, running a batch job to process a large dataset would be considered a job in a cloud environment. On the other hand, a workload refers to a broader set of tasks and processes that are ongoing in the cloud environment. Workloads are typically more complex than individual jobs and may involve multiple tasks running in parallel.

For example, a web application running on a cloud server would be considered a workload, as it involves multiple processes running concurrently to handle user requests. While both jobs and workloads involve tasks that need to be executed in a cloud environment, jobs are typically more discrete and have a defined start and end time, while workloads are ongoing and involve multiple tasks running in parallel. While the context provided mentions jobs as an example, this is not intended to be limiting. Instead, the disclosed approach described herein encompasses the use of workloads, applications, and/or similar concepts.

Receiver module 208 is configured to receive user configuration 202 and deadline for job execution 204. User configuration 202 can include compute requirements such as processing power (e.g., central processing unit (CPU) requirements, graphic processing unit (GPU) requirements), memory, storage, and network bandwidth that are needed to run the job. A deadline for job execution in a cloud environment refers to the date and time by which the job must begin execution within the cloud computing platform. CPU is the amount of processing power required by a job and will depend on the complexity of the task being performed. Some jobs may require multiple CPUs to complete quickly. GPU refers to the amount of processing power required to handle intensive graphics rendering tasks.

Memory refers to the amount of memory required by a job and will depend on the size of the data being processed and the amount of parallelism in the job. Some jobs may require large amounts of memory to be able to process large datasets. Storage is the amount of storage required by a job and will depend on the size of the data being processed and the type of storage required. Some jobs may require high-speed storage, such as SSDs, to achieve high performance. Network bandwidth refers to the amount of network bandwidth required by a job and will depend on the amount of data being transferred between the job and other systems. Some jobs may require high-speed network connections to transfer large amounts of data quickly. The examples of compute requirements described above are not intended to be limiting and can include any compute requirements now known or to be developed in the future.

Broker module 210 is further configured to query any number of available queues to determine the wait times of each queue for a job based on job user configuration 202. For simplicity, available queues are depicted as queue A 214, queue B 216, and queue n 218. The wait time refers to the waiting time a job spends in a queue before it can begin executing. In a cloud computing environment, a queue for scheduling jobs refers to a data structure used to manage and prioritize the execution of tasks or jobs. It typically operates on a first-in, first-out (FIFO) principle, where the earliest arriving job is processed first. When multiple tasks or jobs are submitted to the cloud system, they are placed in a queue until system resources become available to execute them. This allows for efficient allocation of resources and prevents overwhelming the system.

The queue can help maintain order and fairness by ensuring that each job gets its turn based on its arrival time. In some examples, a load sharing facility (LSF) system or technique can be used to predict an approximate start time for these pending jobs by using a simulation-based job start time estimator that runs on the management host. In an embodiment, broker module 210 may interact with a queue broker to ascertain queue wait times. A queue broker can be provided as a managed service by a cloud provider and can be used to facilitate communication between applications by managing message queues. It acts as an intermediary between the producer and consumer applications, ensuring that messages are delivered reliably and in the correct order.

Broker module 210 is further configured to perform a comparison between the determined wait times and the deadline for job execution 204. Again, deadline for job execution 204 refers to a date and time by which the job should begin its execution. If the deadline is met for a particular queue, the job will be placed in that queue for impending execution. If multiple queues are found to meet the deadline, the job will be placed in the queue having the shortest wait time for execution. If the deadline cannot be met, machine learning module 212 is configured to utilize a machine learning model to suggest a modification to user configuration 202 to reduce wait times to meet the provided deadline.

The trained machine learning model for job scheduling can include a historical database 220 of previous job executions. The database can contain a record of any or all jobs that have been executed in the cloud environment, including details about each job's resource requirements, state of the environment during job execution (e.g., available CPU, GPU, memory, etc.), job execution time, and job execution outcome. The model would be trained using this data to predict the optimal configuration for a job based on its requirements and deadline. This can involve using techniques such as a regression analysis, decision tree, and/or other technique now known or to be developed in the future to identify patterns in the data and make predictions about any number of user requirement updates that can be made to minimize a queue wait time.

Regression analysis is a statistical technique used to explore and quantify the relationship between a dependent variable and one or more independent variables. It aims to understand how changes in the independent variables affect the dependent variable. By fitting a regression model to the data, it estimates the mathematical equation that best describes the relationship between the variables. The dependent variable, also known as the response or outcome variable, is the one being predicted or explained. Independent variables, also called predictors or explanatory variables, are factors that may influence or explain the variation in the dependent variable. In this context, the dependent variable is a queue wait time, while the independent variables are the reflected in the values provided in user configuration 202.

Since multiple available queues can be available, multi-output regression (or multi-target regression) can be used. Multi-output regression is a supervised machine learning task where the goal is to predict multiple continuous target variables simultaneously. In contrast to traditional regression, which predicts a single output variable, multi-output regression models aim to capture complex relationships between input features and multiple dependent variables. In multi-output regression, the input data consists of a set of features, and the corresponding output consists of multiple continuous variables. The model learns from the training data to map the input features to the multiple output variables. This can be useful in various real-world scenarios, such as predicting multiple stock prices, estimating the prices of different real estate properties, or forecasting multiple weather variables like temperature, humidity, and precipitation.

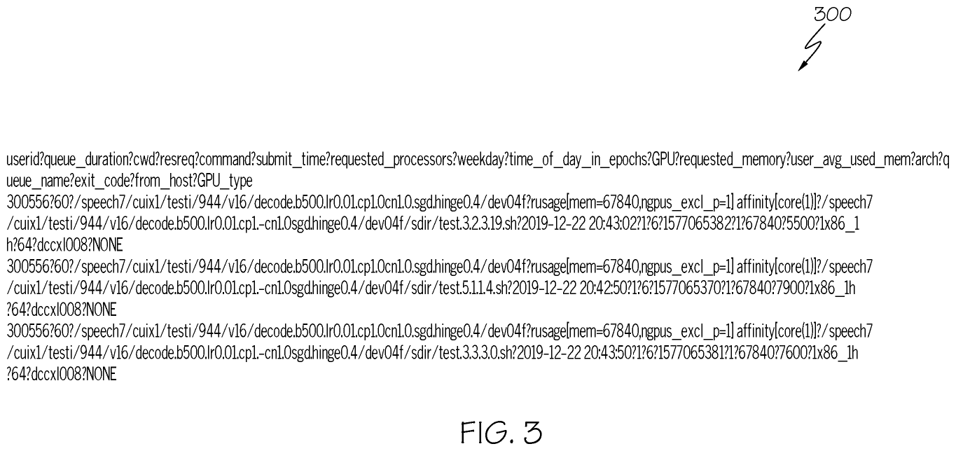

FIG. 3 shows example training data 300 used for a multi-output regression model. In multi-output regression, the training data can include multiple sets of input and output variables to teach the model how to predict all the output variables at once. As shown, input provided by the user includes a command, current working directory, weekday, workload name, User ID, deadline, requested CPU, requested GPU, and requested memory. The generated output includes CPU, GPU, memory, and environment. To perform multi-output regression, various algorithms can be employed, including decision trees, random forests, support vector regression, or neural networks. These models are trained using labeled data, where both the input features and the corresponding target values are provided. The training process involves optimizing the model's parameters to minimize the prediction errors across all the output variables simultaneously. Once the multi-output regression model is trained, it can be used to make predictions on new, unseen data by taking the input features (e.g., user configuration 2020) and producing estimates for all the target variables (e.g., CPU, GPU, etc.).

A decision tree is a predictive modeling technique that uses a tree-like structure to make decisions or predictions based on input features or variables. Each node in the decision tree represents a feature or attribute, and the branches represent the possible outcomes or decisions. The tree starts with a root node and splits into different branches based on the values of the input features. At each internal node, a decision is made based on the value of a particular feature, and the tree branches out accordingly. This process continues recursively until reaching the leaf nodes, which provide the final predicted outcome or decision. The splitting of nodes is done using various criteria, such as entropy or Gini impurity, which determine the optimal way to divide the data based on the features' values. The goal is to create homogeneous subsets at each node that maximize the predictive accuracy of the tree. Decision trees can handle both categorical and numerical data, and they can be used for feature selection and data exploration. Additionally, decision trees can be combined to form ensemble methods like random forests or gradient boosting, which often improve predictive performance.

As described above, once the model has been trained, it can be used to make predictions about an optimal configuration for the job based on the requirements (i.e., user configuration 202) and deadline for job execution 204. This can help to optimize job scheduling and ensure that jobs are executed as efficiently as possible, minimizing wait times and meeting user deadlines. For example, user configuration 202 can be modified to use less GPU or less memory, which can minimize the wait time to meet the deadline for job execution 204. The process is repeated until a satisfactory configuration is found or a predefined threshold for retries is reached. If no suitable configuration is found, the job can be sent to another cloud environment for execution.

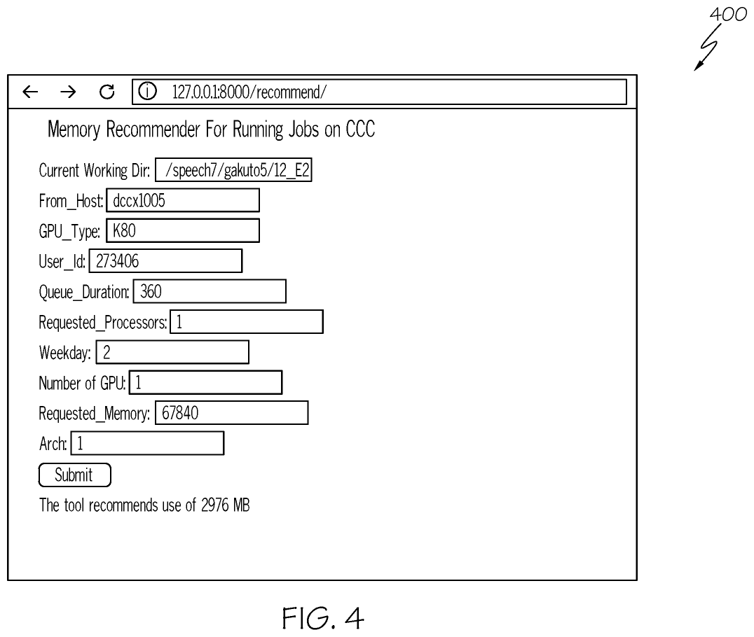

FIG. 4 shows an example user interface (UI) 400 that allows a user to provide user input (i.e., user configuration data) related to a job to be executed. As shown, UI 400 allows the user to provide values for a current working directory, from host, GPU type, user ID, queue duration, number of requested processors, number of a weekday, number of GPUs, requested memory, and an architecture number. A neural network architecture that can be used to predict memory usage of the job based on the values provided via UI 400.

A neural network architecture is a set of interconnected nodes or artificial neurons arranged in layers that can learn and recognize patterns in data. It consists of an input layer that takes in data (e.g., values provided via UI 400), one or more hidden layers that process the data, and an output layer that provides a prediction or classification based on the processed data. The connections between the nodes are weighted, and the weights are adjusted during training to optimize the model's performance. Neural network architectures can be used for a variety of tasks such as image recognition, natural language processing, and prediction in various fields.

In this context, the neural network architecture can be used to predict the memory usage of a job in a cloud environment. The architecture would have an input layer that takes in data related to the job, such as the size of the data being processed, and the type of processing being done. The hidden layers would analyze and process the data, and the output layer would provide a prediction of the memory usage of the job. The neural network would be trained on a dataset of past jobs and their memory usage to learn the patterns and relationships between the input and output variables. This prediction can then be used to allocate appropriate memory resources to the job in the cloud environment to ensure smooth and efficient processing.

The neural network architecture can also be used to predict the processing usage of a job in a cloud environment. Again, the architecture would have multiple layers of interconnected nodes that can learn and recognize patterns in the data. The input layer would take in data related to the job, such as its size, complexity, and resource requirements. The hidden layers would analyze and process the data, and the output layer would provide a prediction of the processing usage of the job. As stated, the neural network would be trained on a dataset of past jobs and their processing usage to learn the patterns and relationships between the input and output variables. This prediction can then be used to allocate appropriate resources to the job.

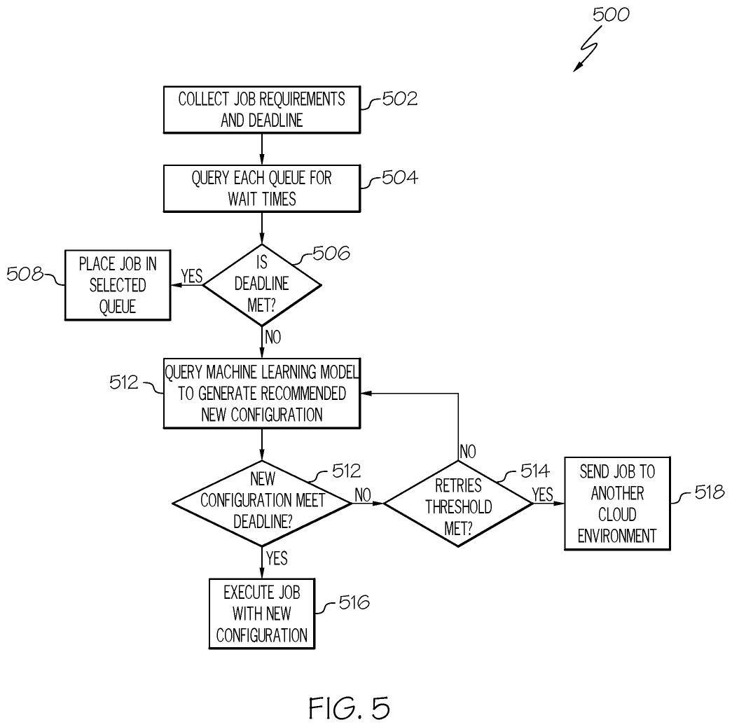

FIG. 5 depicts a flowchart diagram related to optimizing usage and providing recommendations to users in a hybrid cloud environment. At 502, receiver module 208 collects user configuration 202 and deadline for job execution 204 for a job to be executed. At 504, broker module 210 queries available queues to determine a wait time corresponding to each of the available queues for the job based on user configuration 202. Broker module 210 then compares the wait times to the deadline for job execution 204, at 506. If a queue can meet the deadline, the job is placed in that queue, at 508. If multiple queues can meet the deadline, the job is placed in the queue with the shortest wait time. At 510, if the deadline cannot be met, machine learning module 212 suggests modifications to the user configuration 202 to reduce wait times and meet the deadline. This process is repeated until a satisfactory configuration is found or a predefined retry threshold is reached (see steps 510 to 514). If a configuration that meets the execution deadline for a specific queue is found, the job is added to that queue for execution, at 516. However, if a suitable configuration cannot be found, the job may be sent to a different cloud environment for execution, at 518. The goal is to optimize job scheduling and ensure efficient execution while minimizing wait times and meeting user deadlines.

The disclosed approach focuses on improving user experience by recommending a job resource configuration that optimizes the available resources in a hybrid cloud environment. The aim is to minimize wait times for job execution and ensure that users meet their deadlines. This approach includes a machine learning model that suggests configurations to users based on their specified job start time, resulting in streamlined scheduling performance in a hybrid cloud environment. Ultimately, this approach simplifies the process and improves the overall experience for users.

The illustrated steps in FIG. 5 are not necessarily performed in the order shown, and some steps may be performed concurrently or in a different order than shown. The flowchart diagram is intended to illustrate the general flow of the method and is not intended to be limiting. Additional steps may be added, or some steps may be omitted without departing from the scope of the invention. The steps may be performed by a computer program or by a combination of hardware and software. The flowchart diagram may be implemented using any suitable programming language or tool.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optimizing job scheduling performance in a hybrid cloud environment, comprising:
obtaining, by a processor, a user configuration data and a deadline for job execution for a job to be executed;
querying, by the processor, available queues to determine a wait time corresponding to each of the available queues for the job based on the user configuration data;
comparing, by the processor, the wait times to the deadline for job execution; and
suggesting, by the processor, a modification to the user configuration data using a machine learning module to reduce wait times and meet the deadline if the deadline cannot be met.

2. The method of claim 1, further comprising placing, by the processor, the job in a queue that can meet the deadline for job execution if found.

3. The method of claim 1, further comprising obtaining, by the processor, the user configuration data from a user interface.

4. The method of claim 3, wherein the user configuration data includes at least one of central processing unit requirement, graphic processing unit requirement, memory, storage, or network bandwidth.

5. The method of claim 1, wherein the machine learning model is trained using data from previous job executions.

6. The method of claim 1, wherein the available queues are queried via a queue broker.

7. The method of claim 1, further comprising sending, by the processor, the job to another cloud environment for execution when a queue that can meet the deadline for job execution is not found.

8. A computing system for optimizing job scheduling performance in a hybrid cloud environment, comprising:
a processor;
a memory device coupled to the processor; and
a computer readable storage device coupled to the processor, wherein the storage device contains program code executable by the processor via the memory device to implement a method, the method comprising:
obtaining, by a processor, a user configuration data and a deadline for job execution for a job to be executed;
querying, by the processor, available queues to determine a wait time corresponding to each of the available queues for the job based on the user configuration data;
comparing, by the processor, the wait times to the deadline for job execution; and
suggesting, by the processor, a modification to the user configuration data using a machine learning module to reduce wait times and meet the deadline if the deadline cannot be met.

9. The computing system of claim 8, the method further comprising placing, by the processor, the job in a queue that can meet the deadline for job execution if found.

10. The computing system of claim 8, the method further comprising obtaining, by the processor, the user configuration data from a user interface.

11. The computing system of claim 10, wherein the user configuration data includes at least one of central processing unit requirement, graphic processing unit requirement, memory, storage, or network bandwidth.

12. The computing system of claim 8, wherein the machine learning model is trained using data from previous job executions.

13. The computing system of claim 8, wherein the available queues are queried via a queue broker.

14. The computing system of claim 13, the method further comprising sending, by the processor, the job to another cloud environment for execution when a queue that can meet the deadline for job execution is not found.

15. A computer program product for optimizing job scheduling performance in a hybrid cloud environment, the computer program product comprising a computer readable storage device, and program instructions stored on the computer readable storage device, to:
obtain, by a processor, a user configuration data and a deadline for job execution for a job to be executed;
query, by the processor, available queues to determine a wait time corresponding to each of the available queues for the job based on the user configuration data;
compare, by the processor, the wait times to the deadline for job execution; and
suggest, by the processor, a modification to the user configuration data using a machine learning module to reduce wait times and meet the deadline if the deadline cannot be met.

16. The computer program product of claim 15, further comprising program instructions stored on the computer readable storage device to place, by the processor, the job in a queue that can meet the deadline for job execution if found.

17. The computer program product of claim 15, further comprising program instructions stored on the computer readable storage device to obtain, by the processor, the user configuration data from a user interface.

18. The computer program product of claim 17, wherein the user configuration data includes at least one of central processing unit requirement, graphic processing unit requirement, memory, storage, or network bandwidth.

19. The computer program product of claim 15, wherein the machine learning model is trained using data from previous job executions.

20. The computer program product of claim 15, wherein the available queues are queried via a queue broker.
